(19) United States
(12) Patent Application Publication
(10) Pub. No.: US 2013/0254868 A1
(43) Pub. Date: Sep. 26, 2013

(54) SYSTEM AND METHOD FOR MULTIMEDIA MULTI-PARTY PEERING (M2P2)

(71) Applicant: Bhumip Khasnabish, Lexington, MA (US)

(72) Inventor: Bhumip Khasnabish, Lexington, MA (US)

(73) Assignee: ZTE USA Inc, Richardson, TX (US)

(21) Appl. No.: 13/878,549

(22) PCT Filed: Oct. 13, 2011
(86) PCT No.: PCT/US11/56158

§ 371 Date: Jun. 11, 2013

Related U.S. Application Data
(60) Provisional application No. 61/392,575, filed on Oct. 13, 2010.

(51) Int. Cl. H04L 12/70

(52) U.S. Cl. CPC H04L 47/70; H04L 63/0272
USPC 726/11; 709/226

(57) ABSTRACT

Embodiments of the present invention pertain to systems and methods for implementing a platform to support multimedia services peering with multiple independent competing parties, such as carriers or service providers. More particularly, certain embodiments of the invention pertain to deployment of the same physical platform or device by using soft- and hard-virtual separation of resources. Each party is allowed to retain full control over its logical resources space, even when a party is not using any of its resources. However, the multimedia multi-party peering provider maintains complete overview of the utilization of resources by each party via an active monitoring and enforcing method.

### FIELD OF THE INVENTION

This invention pertains to a system and method for multimedia multi-party peering (M2P2). More particularly, embodiments of the present invention relate to a system and method for soft- and hard-controlling of multi-party peering of multimedia services using the same physical platform or device. Specifically, certain embodiments of the present invention relate to facilitating controlled use of peering resources over a shared platform, thus reducing both the number of physical devices and their connectivity requirements to support multi-party peering of multimedia services without sacrificing security and resource sharing for continued availability.

### BACKGROUND

Peer-to-peer scenarios may be exemplified by the absence of a “server” in a traditional client-server environment. Such a paradigm may be viewed as an instance of distributed computing, where a system of (often heterogeneous) nodes operate in a cooperative or confederated fashion to complete a given task. Peer nodes can be viewed as taking on the roles of both a client and a server. Current peer-to-peer infrastructures, however, typically do not provide flexible/dynamic support for operations such as multimedia services.

For example, in a peer-to-peer environment, data is likely to be transmitted over a variety of heterogeneous communication media including telephone lines, high-speed wired networks, wireless local area networks, Bluetooth networks, and mobile cellular networks, and the like. Typically, in existing peer-to-peer networks, the transport protocols used are reliable in nature. While this approach masks the specifics of the underlying channel and is amenable to rapid prototyping and implementation, it may not be well suited for real-time delivery of multimedia data. Further, even in the case of delay-insensitive media data, wireless peers are likely to have limited storage resources and the concurrent playback and streaming of the data may thus be limited.

Current methods of supporting M2P2 use multiple physical interconnection devices (i.e., multiple platforms) and multiple interconnections. Such methods call for an increased number of devices and interconnections and add to the cost and complexity of managing a huge facility for M2P2. In addition to these drawbacks, debugging, diagnosis, and monitoring of service quality becomes more complicated and cost-prohibitive. In general, the number of devices increases linearly as the number of peering partners increases. This is because the only way to increase capacity is to add more physical devices (platforms) and interconnections when an increased capacity is required, even where the current platforms are at times not fully utilized.

### SUMMARY OF THE INVENTION

Computer hardware is generally designed to run a single operating system and a single application, leaving most machines vastly underutilized. Virtualization, however, allows multiple “virtual machines” to run on a single physical machine, with each virtual machine sharing the resources of that one physical machine across multiple environments. Different virtual machines can run different operating systems and multiple applications on the same physical computer, for example. Thus, a virtual machine behaves like a physical computer and contains its own virtual (i.e., software-based) resources, and is independent from underlying hardware. Moreover, virtual machines may make up a virtual infrastructure, which may represent the interconnected hardware resources of an entire IT infrastructure, for example.

In general, the present invention overcomes certain drawbacks of current practices supporting multi-party multimedia peering according to the following systems, methods, and means of the present invention:

A physical device is employed for supporting multiple peering partners (i.e., tenants) instead of using multiple physical devices;

The number of physical connections that are needed is reduced since multi-tenancy can be supported via virtualized resources;

Physically disjointed resources—clusters of resources in different racks in the same room or in geographically distributed facilities, for example—are more cost-effectively utilized and scaled;

Additional resources are not required for providing monitoring and enforcement of quota of resource allocation to the peering partners; and/or

Rapid repositioning or re-purposing of resources (RRR or R3 or R-cube) is easily achieved since virtualized instances are utilized for service provisioning and monitoring.

According to an exemplary embodiment of the present invention, the number of devices is substantially reduced and physical devices (platforms) are only incrementally added when increased capacity is required. This is achieved by creating multiple virtual instances of the same physical resources.

In addition, using Active Monitoring and Enforcement (AMEN), the required active monitoring can be achieved by using virtualized shared resources (instead of dedicating resources for that purpose) which substantially reduces cost, complexity, and resources requirements because, for example, no additional physical resources are required. In addition, since AMEN is active, the monitoring and enforcement actually allocates resources rather than merely passively watching and reporting system activity.

Indeed, according to an exemplary embodiment of the present invention, the method allows dynamic allocation of virtualized resources to the peering sessions of the party for which the session needs to be actively maintained. Thus, neither pre-allocation nor preset commitment of resources to any of the parties that are using the service is required. This results not only in substantial savings of resources deployment but also reduces the cost and complexity of active monitoring and enforcement of resources utilization.

More particularly, in certain embodiments of the present invention, there is provided a multimedia multi-party peering system that includes one or more platforms configured to peer multimedia and that have physical and virtualized resources. The system further includes one or more mechanisms configured to allocate and manage the virtualized resources among the one or more platforms. The virtualized resources may include a processing category, a storage category, and/or a bandwidth category, wherein the processing category includes one or more of a central processing unit, a graphics processing unit, and a digital signal processor; the storage category comprises one or more of a random access memory, a data storage, and a DataBase; and the bandwidth category comprises logical and physical connectivity resources.

The system optionally further includes an active monitoring and enforcing mechanism configured to use the virtual resources to implement active monitoring and enforcement of a quota. The active monitoring and enforcing mechanism can be incorporated where premium customer services reside and/or be moveable from one location to another.

A Public and/or private web-based application programming interface configured to allow access to the virtual resources optionally is further included in the system. The public/private web-based application programming interface can be configured to use over the top access via the Internet using a virtual firewall, an authentication server, and a certification server, wherein the virtual firewall, the authentication server, and the certification server are created using the virtual resources.

In certain embodiments of the present invention, there is provided a method of peering in a multimedia multi-party system having physical resources that includes the steps of creating virtual instances of physical resources having a processing category, a storage category, and/or a bandwidth category; and dynamically allocating the virtualized instances. Moreover, the processing category optionally includes one or more of a central processing unit, a graphics processing unit, and a digital signal processor; the storage category optionally includes one or more of a random access memory, a data storage, and a DataBase; and the bandwidth category optionally includes logical and physical connectivity resources.

The method optionally further include the step of using an active monitoring and enforcement mechanism that uses the virtual instances to enforce a quota. The active monitoring and enforcement mechanism can be incorporated where premium customer services reside and/or be movable from one location to another.

The method optionally further includes the step of using a public and/or private web-based application programming interface to allow access to the virtual instances, wherein the public/private web-based application programming interface can use over the top access via the Internet using a virtual firewall, an authentication server, and a certification server, which are created using the virtual instances.

### BRIEF DESCRIPTION OF THE DRAWINGS

Having thus described the invention in general terms, a more complete understanding of the present invention may be realized by reference to the accompanying drawings, which are not necessarily drawn to scale. Moreover, in the drawings, well-known elements in the relevant art have been omitted in order not to obscure the present invention in unnecessary detail.

FIG. 1 shows an embodiment of the present invention wherein M2P2 uses virtualized resources (processing to storage to bandwidth).

FIG. 2 shows incorporation of an AMEN mechanism in M2P2 according to certain embodiments of the present invention.

FIG. 3 shows Web-based public and private Application Programming Interface (API) for supporting AMEN-ized M2P2 according to certain embodiments of the present invention.

The following described examples of certain embodiments of the invention may be embodied in many different forms and should not be construed as limited to the embodiments set forth herein; rather, these embodiments are provided by way of example to satisfy applicable legal requirements.

### DETAILED DESCRIPTION OF THE PREFERRED EMBODIMENTS OF THE PRESENT INVENTION

“Virtualization” is the abstraction of physical resources by software, which veils the physical infrastructure of computational resources to be submitted to one or more applications or operating systems in order to share them. For example, it is the creation of a virtual (rather than actual) version of something, such as an operating system, a server, a storage device, network resources, or a combination of the foregoing. Virtualization in general, regardless of how it is implemented, uses some level of abstraction (separation) to allow resources to be pooled and shared so that applications are more loosely coupled to underlying hardware. Virtualization techniques are generally well known in the art.

“AMEN,” as used herein, refers to active monitoring and enforcement of policies, security procedures, the performance of computers systems, networks, and the like. Active monitoring and enforcement actually allocates resources, rather than merely passively watching and reporting system activity. Similarly, AMEN-ized refers to a M2P2 system that incorporates AMEN, as disclosed herein.

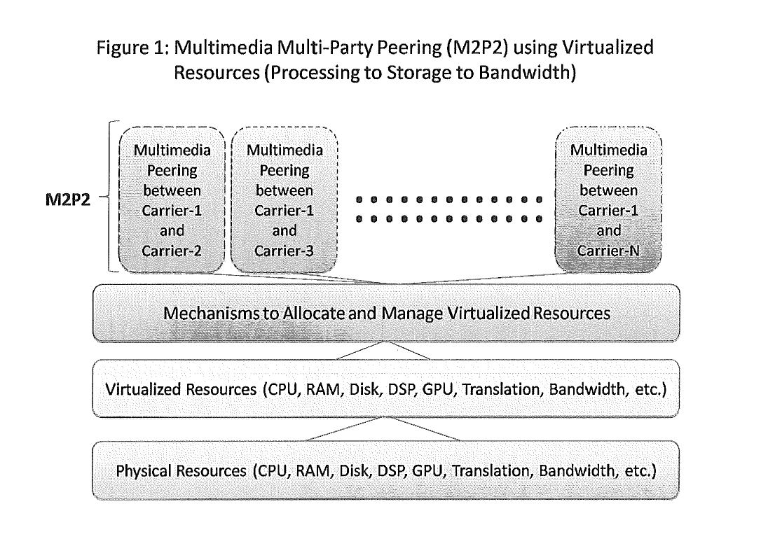

FIG. 1 of the present invention shows a realization of M2P2 using virtualized resources. As is known in the art, resource virtualization is routinely performed via abstraction of physical resources and effectively decoupling the physical resources from their users. This type of instantiation and dynamic assignment/management of resources not only reduces implementation costs but also helps rapid repositioning (or repurposing) of costly physical resources. Dynamic allocation of virtual resources, for example, can be implemented using common mechanisms such as round robin, random, last-in-first-out, first-in-last-out, and the like.

Due to the use of virtualized resources, for example, the number of devices is substantially reduced and physical devices (platforms) are only incrementally added when increased capacity is required. This is achieved by creating multiple virtual instances of the same physical resources. As a result, one physical device, for example, can be used to support multiple peering partners (tenants), instead of using multiple physical devices that may be dedicated or pre-allocated. Indeed, the virtualized resources can be allocated for any purpose. Moreover, the number of physical connections that are needed is reduced because multi-tenancy is supported by means of virtualized resources. As a result, the system becomes more robust and efficient.

In general, certain embodiments of the present invention also allow for rapid repositioning or re-purposing of resources due to utilization of virtualized instances for service provisioning and monitoring. This is achievable because of decoupling between physical resources and their users (abstraction), as discussed earlier. The virtualized resources are used for service implementation (e.g., M2P2), service quality monitoring, and the like.

The resources that are virtualized, for example, include processing (i.e., central processing unit (CPU), graphics processing unit (GPU), digital signal processing (DSP)); storage (i.e., random access memory (RAM), data storage or disk, DataBase (DB) to support translation and/or hosting services); and/or bandwidth (i.e., logical and physical connectivity resources to support multimedia session across a peering interface and for monitoring and enforcing resource utilization).

Embodiments of the present invention allocate the same physical resources to multiple users, which allows for significant savings on power consumption, physical space, and the like, for example. Indeed, the more diffuse the users and their associated resources, the higher the number of users that can be allocated to fewer physical resources. For example, if resources in a first area experience peak usage at one time of day and resources in a second area experience peak usage at another time of day, both areas may experience significant periods of non-peak usage times wherein their respective resources are significantly underutilized. By effectively combining and virtualizing both resource locations, the combined resources can be dynamically allocated to all users, resulting in significant savings. In effect, a time-sharing system can be implemented.

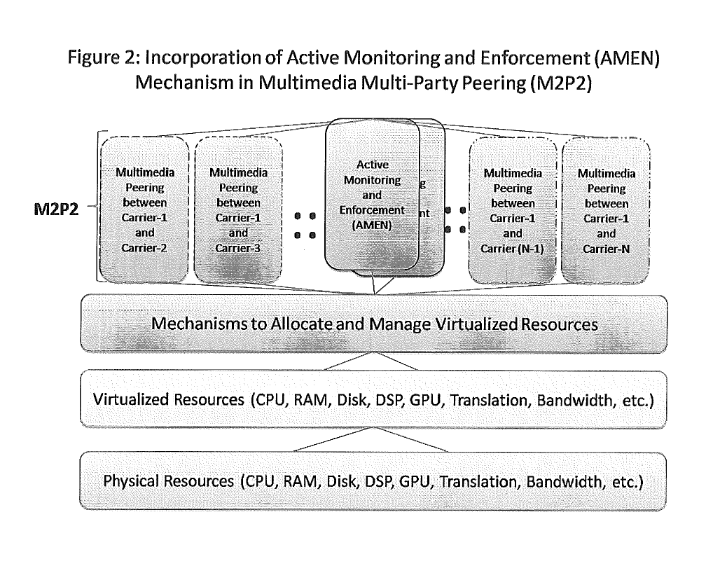

FIG. 2 shows incorporation of AMEN mechanism in a M2P2 system according to certain embodiments of the present invention. More particularly, FIG. 2 shows incorporation of AMEN by using virtualized shared resources, as required or on an on-demand basis. AMEN is incorporated as closely as possible to the service hot-spot or at the points where premium customers' services reside. Moreover, AMEN points can be moved from one location to another because AMEN also employs virtualized resources. By use of AMEN, the required active monitoring can be achieved by using virtualized shared resources, instead of dedicating resources for that purpose; which also substantially reduces cost, complexity, and/or resources requirements.

The same physical resources that are employed for M2P2 are also employed for AMEN services since virtualized instances of resources are utilized for this purpose. The virtualized resources are utilized to implement active monitoring and enforcement of the quota that are allocated to multimedia multiparty peering. Therefore, additional physical instances of specialized resources are not required for AMEN. This reduces both the cost and/or complexity of managing infrastructure and resources for AMEN services in a M2P2 system.

As noted, embodiments of the present invention incorporate AMEN, which employs active, rather than passive, monitoring and enforcement. As a result, the system becomes more robust and efficient. Passive monitoring systems, on the other hand, are generally configured to simply scan traffic and to conduct performance tasks based on recognized behavior. For example, one performance task could involve measuring signal strength. Another performance task could involve determining whether a peer is authorized or unauthorized. If any problems are detected, passive monitoring systems do not have any capability to correct such problems. For instance, upon detection of an unauthorized peer, a passive monitoring system may send a notification to an administrator to prevent access. This inability of monitoring systems to automatically handle problems and enforce policy followed by the network may cause undesirable latency in correcting problems and increased overall administrative costs, for example. As such, implementation of active monitoring and enforcement of a quota allocated for multimedia multiparty peering, as is involved in certain embodiments of the present invention, is advantageous.

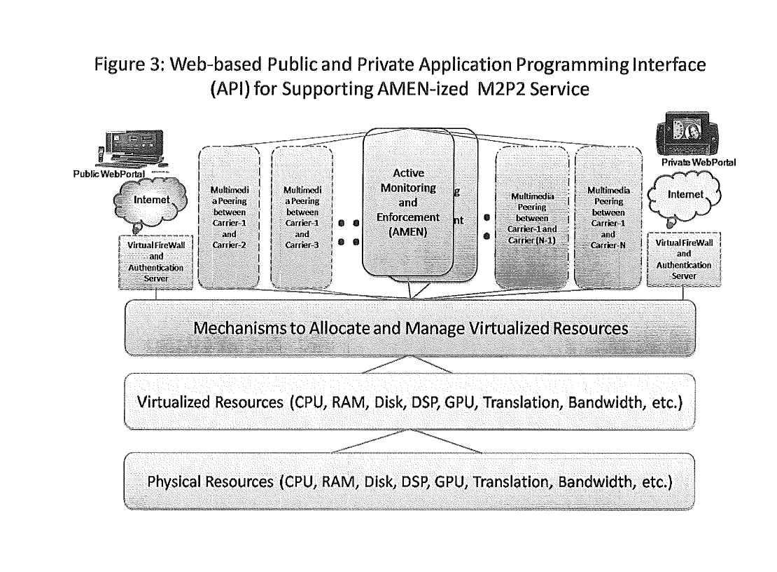

FIG. 3 shows how Web-based private and public interfaces can be supported in the proposed system for AMEN-ized M2P2 service, as described above.

More particularly, FIG. 3 shows Web-based Public and Private Application Programming Interface (API) for supporting AMEN-ized M2P2 Services. These APIs allow access to virtualized resources using over the top (OTT) access via the Internet using virtual FireWall, and authentication and certification servers. The firewall, authentication server, and certification server, for example, are also created using the same virtual resources that are utilized to support M2P2 and to perform the AMEN functions. As such, no additional physical infrastructures need to be developed and maintained for supporting these private and public APIs. The private APIs support access to the resources and services via PCs, laptops, desktops, and even cell phones, for example. The public APIs, for example, can optionally support access to the resources and services through PCs in public places through login and password protected access.

The foregoing descriptions illustrate and describe certain embodiments of the present invention. It is to be understood that the invention is capable of use in various other combinations, modifications, and environments; and is capable of changes or modifications within the scope of the inventive concept as expressed herein, commensurate with the above teachings and/or skill or knowledge in the relevant art.

The embodiments described hereinabove are further intended to explain best modes known of practicing the invention and to enable others skilled in the art to utilize the invention in such, or other, embodiments; and with the various modifications required by particular applications or uses of the invention. Further, it should be understood that the methods and systems of the present invention are executed employing machines and apparatus including simple and complex computers.

Indeed, the architecture and methods described above can be stored on forms of machine-readable media, including magnetic and optical disks. For example, the operations of the present invention could be stored on machine-readable media, such as magnetic disks or optical disks, which are accessible via a disk drive (or computer-readable medium drive). Alternatively, the logic to perform the operations as discussed above, could be implemented in additional computer and/or machine readable media, such as discrete hardware components as large-scale integrated circuits (LSI's), application-specific integrated circuits (ASIC's), firmware such as electrically erasable programmable read-only only memory (EEPROM's); and the like.

Adaptations of known systems and methods that are apparent to those skilled in the art based on the description of the invention contained herein are within the scope of the claims. Moreover, later-invented or -developed equipment that carries out the methods and/or combination elements set forth in the claims are within the scope of the invention. Accordingly, the description is not intended to limit the invention to the form or application disclosed herein.

1-34. (canceled)

35. A multimedia multi-party peering system comprising:
one or more platforms, the one or more platforms configured to peer multimedia and comprising physical resources; and
virtualized resources; and one or more mechanisms configured to allocate and manage the virtualized resources among the one or more platforms.

36. The system of claim 35, wherein the virtualized resources comprise a processing category, a storage category, and a bandwidth category.

37. The system of claim 36, wherein:
the processing category comprises one or more of a central processing unit, a graphics processing unit, and a digital signal processor;
the storage category comprises one or more of a random access memory, a data storage, and a DataBase; and
the bandwidth category comprises logical and physical connectivity resources.

38. The system of claim 35, further comprising an active monitoring and enforcing mechanism, wherein the active monitoring and enforcing mechanism is configured to use the virtual resources to implement active monitoring and enforcement of a quota.

39. The system of claim 38, further comprising a public web-based application programming interface configured to allow access to the virtual resources.

40. The system of claim 39, wherein the public web-based application programming interface is further configured to use over the top access via the Internet using a virtual firewall, an authentication server, and a certification server.

41. The system of claim 40, wherein the virtual firewall, the authentication server, and the certification server are created using the virtual resources.

42. The system of claim 38, further comprising a private web-based application programming interface configured to allow access to the virtual resources.

43. The system of claim 42, wherein the private web-based application programming interface is further configured to use over the top access via the Internet using a virtual firewall, an authentication server, and a certification server.

44. The system of claim 43, wherein the virtual firewall, the authentication server, and the certification server are created using the virtual resources.

45. The system of claim 38, wherein the active monitoring and enforcing mechanism is incorporated where premium customer services reside.

46. The system of claim 38, wherein the active monitoring and enforcing mechanism is movable from one location to another.

47. A method of peering in a multimedia multi-party system having physical resources comprising the steps of:
creating virtual instances of the physical resources, wherein the physical resources comprise a processing category, a storage category, and a bandwidth category; and
dynamically allocating the virtualized instances.

48. The method of claim 47, wherein:
the processing category comprises one or more of a central processing unit, a graphics processing unit, and a digital signal processor;
the storage category comprises one or more of a random access memory, a data storage, and a DataBase; and
the bandwidth category comprises logical and physical connectivity resources.

49. The method of claim 47, further comprising the step of using an active monitoring and enforcement mechanism, wherein the active monitoring and enforcement mechanism uses the virtual instances to enforce a quota.

50. The method of claim 49, further comprising the step of using a public web-based application programming interface to allow access to the virtual instances.

51. The method of claim 50, wherein the public web-based application programming interface uses over the top access via the Internet using a virtual firewall, an authentication server, and a certification server.

52. The method of claim 51, wherein the virtual firewall, the authentication server, and the certification server are created using the virtual instances.

53. The method of claim 49, further comprising the step of using a private web-based application programming interface to allow access to the virtual instances.

54. The method of claim 53, wherein the private web-based application programming interface uses over the top access via the Internet using a virtual firewall, an authentication server, and a certification server.

55. The method of claim 54, wherein the virtual firewall, the authentication server, and the certification server are created using the virtual instances.

56. The method of claim 49, wherein the active monitoring and enforcing mechanism is incorporated where premium customer services reside.

57. The method of claim 49, wherein the active monitoring and enforcing mechanism is movable from one location to another.

58. An article of manufacture including a computer-readable medium having instructions stored thereon, comprising:
instructions for creating virtual instances of physical resources of a multimedia multi-party system, wherein the physical resources comprise a processing category, a storage category, and a bandwidth category; and
instructions for dynamically allocating the virtualized instances.

59. The article of manufacture of claim 58, wherein:
the processing category comprises one or more of a central processing unit, a graphics processing unit, and a digital signal processor;
the storage category comprises one or more of a random access memory, a data storage, and a DataBase; and
the bandwidth category comprises logical and physical connectivity resources.

60. The article of manufacture of claim 58, further comprising instructions for using an active monitoring and enforcement mechanism, wherein the active monitoring and enforcement mechanism uses the virtual instances to enforce a quota.

61. The article of manufacture of claim 60, further comprising instructions for using a public web-based application programming interface to allow access to the virtual instances.

62. The article of manufacture of claim 61, wherein the public web-based application programming interface uses over the top access via the Internet using a virtual firewall, an authentication server, and a certification server.

63. The article of manufacture of claim 62, wherein the virtual firewall, the authentication server, and the certification server are created using the virtual instances.

64. The article of manufacture of claim 60, further comprising instructions for using a private web-based application programming interface to allow access to the virtual instances.

65. The article of manufacture of claim 64, wherein the private web-based application programming interface uses over the top access via the Internet using a virtual firewall, an authentication server, and a certification server.

66. The article of manufacture of claim 65, wherein the virtual firewall, the authentication server, and the certification server are created using the virtual instances.

67. The article of manufacture of claim 60, wherein the active monitoring and enforcing mechanism is incorporated where premium customer services reside.

68. The article of manufacture of claim 60, wherein the active monitoring and enforcing mechanism is movable from one location to another.
